(19) United States
(12) Patent Application Publication
(10) Pub. No.: US 2025/0005846 A1
(43) Pub. Date: Jan. 2, 2025

(54) IMAGE PROCESSING APPARATUS, IMAGE PROCESSING METHOD, AND NON-TRANSITORY COMPUTER-READABLE MEDIUM

(71) Applicant: CANON KABUSHIKI KAISHA, Tokyo (JP)

(72) Inventor: Keisuke MORISAWA, Kanagawa (JP)

(21) Appl. No.: 18/739,365

(22) Filed: Jun. 11, 2024

(30) Foreign Application Priority Data
Jun. 30, 2023 (JP) 2023-108527

(51) Int. Cl. G06T 15/20; G06F 21/10; G06T 7/246; G06T 7/292; G06T 7/73; G06T 19/20

(52) U.S. Cl. CPC G06T 15/205; G06F 21/1014; G06T 7/246; G06T 7/292; G06T 7/73; G06T 19/20; G06T 2207/10016; G06T 2207/30196; G06T 2219/2012; G06T 2219/2016

(57) ABSTRACT

An image processing apparatus is provided. The apparatus obtains a three-dimensional model of the object. The apparatus obtains information indicating a situation of the object. The apparatus generates the virtual viewpoint image of the object according to the three-dimensional model of the object and the information indicating the situation of the object.

### BACKGROUND

### Field

The present disclosure relates to an image processing apparatus, an image processing method, and a non-transitory computer-readable medium, and particularly relates to displaying virtual viewpoint video.

### Description of the Related Art

Techniques are attracting attention in which images are shot in synchronization by a plurality of image capturing apparatuses arranged at different positions, and a virtual viewpoint image seen from a designated virtual viewpoint is then generated using the images obtained from the plurality of viewpoints. According to this technique, for example, highlight scenes from soccer or basketball games can be viewed from a variety of angles. This provides users with a higher sense of immersion than normal images.

A technique is also known which estimates the posture of a person who is an object by using an image of an object shot by a plurality of image capturing apparatuses. For example, Lewis Bridgeman et al. discuss shooting competitions such as soccer games using a plurality of cameras in ‘Multi-person 3d pose estimation and tracking in sports’, Proceedings of the IEEE/CVF conference on computer vision and pattern recognition workshops (2019). Two-dimensional posture information of players in each captured image is also calculated. Three-dimensional posture information of the players is then estimated by combining a plurality of instances of the two-dimensional posture information.

### SUMMARY

According to an embodiment, an image processing apparatus comprises one or more memories storing instructions and one or more processors that execute the instructions to: obtain a three-dimensional model of the object; obtain information indicating a situation of the object; and generate the virtual viewpoint image of the object according to the three-dimensional model of the object and the information indicating the situation of the object.

According to another embodiment, an image processing method comprises: obtaining a three-dimensional model of an object; obtaining information indicating a situation of the object; and generating the virtual viewpoint image of the object according to the three-dimensional model of the object and the information indicating the situation of the object.

According to still another embodiment, a non-transitory computer-readable medium stores a program executable by a computer to perform a method comprising: obtaining a three-dimensional model of an object; obtaining information indicating a situation of the object; and generating the virtual viewpoint image of the object according to the three-dimensional model of the object and the information indicating the situation of the object.

Further features of the present disclosure will become apparent from the following description of exemplary embodiments (with reference to the attached drawings).

### BRIEF DESCRIPTION OF THE DRAWINGS

FIG. 1 is a diagram illustrating an example of a virtual viewpoint video generation system according to one embodiment.

FIG. 2 is a diagram illustrating an example of a camera arrangement.

FIGS. 3A and 3B are diagrams illustrating an example of a captured image and a foreground mask image.

FIGS. 4A and 4B are diagrams illustrating a visual cone intersection method.

FIGS. 5A to 5D are diagrams illustrating a three-dimensional model.

FIG. 6 is a diagram illustrating a coloring method for a three-dimensional model.

FIG. 7 is a diagram illustrating an example of the functional configuration of an image processing apparatus according to one embodiment.

FIG. 8 is a diagram illustrating an example of posture information.

FIGS. 9A to 9D are diagrams illustrating an object posture estimation method.

FIG. 10 is a diagram illustrating an example of a virtual viewpoint image.

FIGS. 11A and 11B are diagrams illustrating examples of virtual viewpoint images generated in accordance with object information.

FIGS. 12A and 12B are diagrams illustrating examples of virtual viewpoint images generated in accordance with object information.

FIG. 13 is a diagram illustrating an example of the hardware configuration of an image processing apparatus according to one embodiment.

FIG. 14 is a flowchart illustrating an image processing method according to one embodiment.

FIG. 15 is a diagram illustrating an example of a user interface for selecting a display mode.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but limitation is not made to require all such features, and multiple such features may be combined as appropriate. Furthermore, in the attached drawings, the same reference numerals are given to the same or similar configurations, and redundant description thereof is omitted.

There is demand for increasing the appeal of virtual viewpoint image content. For example, various virtual viewpoint images can be generated such that a virtual viewpoint can be set. In some virtual viewpoint images, it may not be easy to understand the scene expressed by the virtual viewpoint image. Making it easier for users to understand the scenes expressed by virtual viewpoint images will increase the appeal of the virtual viewpoint images to the users.

One embodiment of the present disclosure can makes increase the appeal of a virtual viewpoint image to a user.

### Overall Configuration

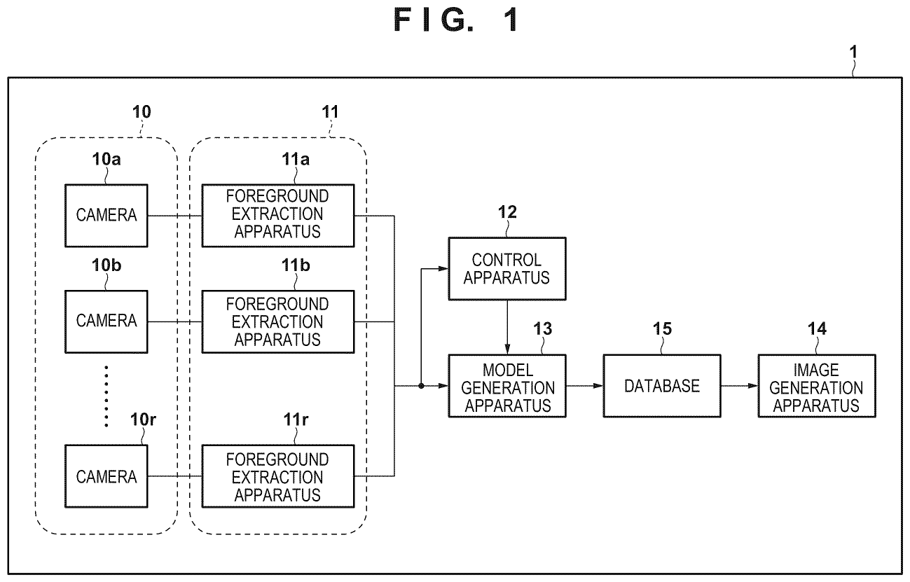

One embodiment of the present disclosure relates to a system for generating a virtual viewpoint image. FIG. 1 is a block diagram illustrating the configuration of an image generation system 1. The image generation system 1 includes a camera array 10, a foreground extraction apparatus group 11, a control apparatus 12, a model generation apparatus 13, an image generation apparatus 14, and a database 15.

The camera array 10 includes a plurality of cameras 10a to 10r. The plurality of cameras 10a to 10r shoot images of an object from a variety of angles. The cameras 10a to 10r output images to corresponding ones of foreground extraction apparatuses 11a to 11r. The cameras 10a to 10r can be arranged around a shooting region 20, as illustrated in FIG. 2. In the example illustrated in FIG. 2, the shooting region is indicated as a rectangle. In this example, the shooting region is a field for a sport such as soccer. The camera array 10 shoots images of the shooting region 20 from a variety of angles at a synchronized timing. This makes it possible to shoot images of people 30a to 30j, and a ball 30k, which are objects.

The foreground extraction apparatus group 11 includes a plurality of foreground extraction apparatuses 11a to 11r. The foreground extraction apparatuses 11a to 11r receive captured images from the corresponding cameras 10a to 10r. The foreground extraction apparatuses 11a to 11r then extract a foreground region, where the foreground is present, from the captured images. “Foreground” refers to the objects displayed in a virtual viewpoint image. In the following example, the foreground includes three-dimensional objects that are objects in a shooting area, such the people 30a to 30j and the ball 30k.

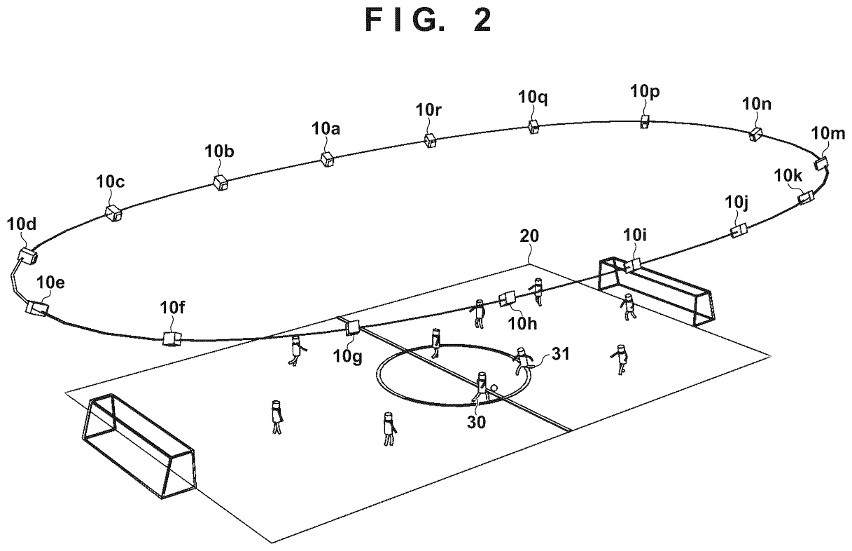

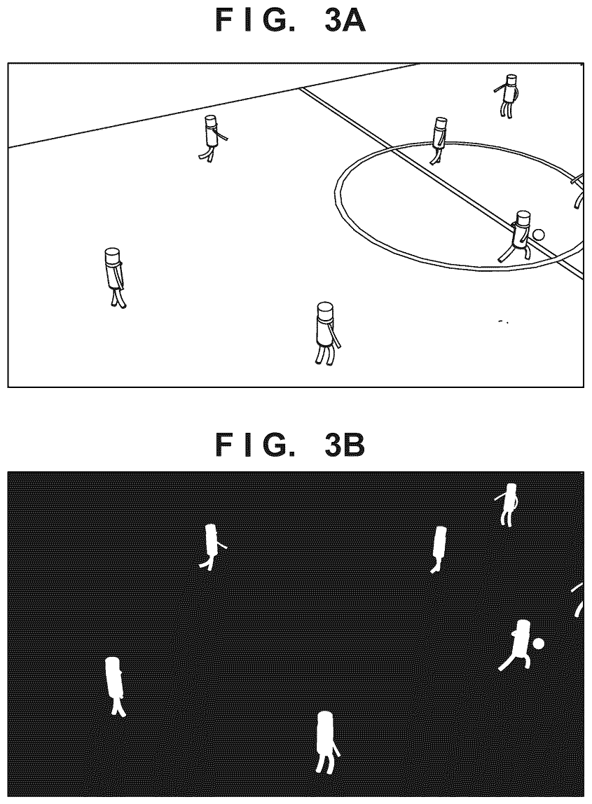

Specifically, each of the foreground extraction apparatuses 11a to 11r can extract a foreground mask image from the captured image. FIG. 3A illustrates an example of a captured image. FIG. 3A illustrates a captured image obtained by the camera 10g. The captured image is a texture image expressing the texture of the objects. The captured image expresses the textures of the foreground, and will also be called a “foreground texture image” hereinafter. The captured image may be a color image, for example. In other words, the color of each pixel in the captured image is expressed by three primary colors, namely R (red), G (green), and B (blue).

FIG. 3B illustrates an example of a foreground mask image extracted from the captured image illustrated in FIG. 3A by the foreground extraction apparatuses 11a to 11r. The foreground mask image expresses the foreground region in the captured image. In this example, the foreground mask image is a binary image. In the foreground mask image, the value of pixels which are in the foreground region is 1 (white, in FIG. 3B). The value of pixels which are in the background region is 0 (black, in FIG. 3B). This foreground mask image expresses a silhouette of the foreground.

The method by which the foreground extraction apparatuses 11a to 11r detect the foreground region is not limited. For example, the foreground extraction apparatuses 11a to 11r can detect the foreground region by comparing a background image held in advance with the captured images. Specifically, each of the foreground extraction apparatuses 11a to 11r can determine that a region having a large luminance difference or a large color difference between the background image and the captured image is the foreground region.

The control apparatus 12 outputs information indicating the positions and postures of the cameras 10a to 10r to the model generation apparatus 13. The control apparatus 12 can calculate camera parameters indicating the respective positions and postures of the cameras 10a to 10r from the captured images obtained by the camera array 10 at the synchronized timing.

The camera parameters can include external parameters and internal parameters. The external parameters indicate the position and posture of the camera. The external parameters may be constituted by a rotation matrix and a translation matrix. The internal parameters indicate the image capturing conditions of the captured image captured by the camera. For example, the internal parameters can include information indicating settings of the optical system of the camera, such as the focal length or optical center of the camera. The internal parameters can indicate the angle of view of the camera or the size of the image sensor.

The processing for calculating the camera parameters is called “calibration”. To perform the calibration, a specific pattern such as a checkerboard can be captured using the cameras 10a to 10r. The control apparatus 12 can perform the calibration using the plurality of captured images obtained as a result. For example, the control apparatus 12 can perform the calibration using a correspondence relationship between points in a three-dimensional space based on a world coordinate system and points in a two-dimensional captured image corresponding thereto.

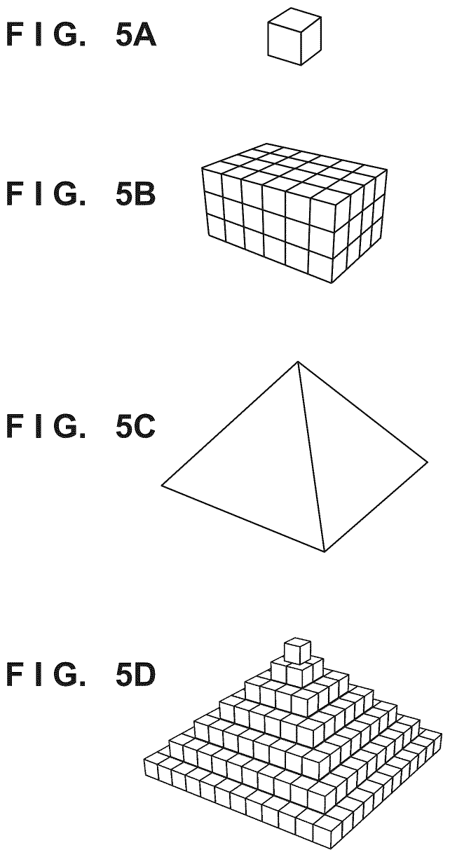

The model generation apparatus 13 generates three-dimensional models of objects. The model generation apparatus 13 can generate a three-dimensional model of each of the objects constituting the foreground. The configuration of the three-dimensional model is not particularly limited. For example, the three-dimensional model may be a collection of voxels. A “voxel” is a small-size cube, for example. FIG. 5A illustrates an example of a single voxel. FIG. 5B illustrates a collection of voxels representing a space where a three-dimensional model is to be generated. FIG. 5C illustrates an example of an object. FIG. 5D illustrates a three-dimensional model representing the object. The three-dimensional model illustrated in FIG. 5D is obtained by approximating the shape of the object illustrated in FIG. 5C using a voxel collection. As the size of the voxels decreases, the three-dimensional model can reproduce the object at a higher level of detail.

The model generation apparatus 13 obtains the camera parameters from the control apparatus 12. The model generation apparatus 13 also obtains the foreground mask image and the foreground texture image from the foreground extraction apparatus group 11. The model generation apparatus 13 can generate a three-dimensional model based on the camera parameters and the foreground mask image. The method for generating the three-dimensional model is not particularly limited. For example, the model generation apparatus 13 can generate a three-dimensional model using a visual cone intersection method. In other words, by using the foreground mask image based on the captured images captured by the cameras 10a to 10r, the model generation apparatus 13 can generate a three-dimensional model of an object represented by a voxel collection through a visual cone intersection method. The model generation apparatus 13 can output the generated three-dimensional model of the object to the database 15. The model generation apparatus 13 can also output the obtained foreground texture image and the camera parameters to the database 15.

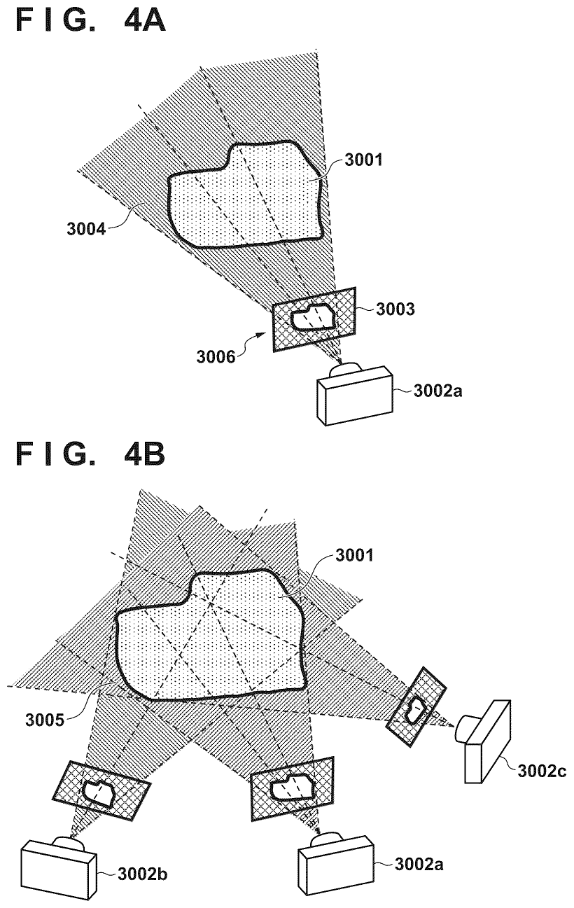

The visual cone intersection method will be described here with reference to FIGS. 4A and 4B. As illustrated in FIG. 4A, a captured image corresponding to an image capture plane 3006 is obtained by capturing an image of an object 3001 using a camera 3002a. As described above, the foreground extraction apparatus (not shown) corresponding to the camera 3002a generates, from the captured image, a foreground mask image 3003 representing a two-dimensional silhouette of the object. Here, the frustum of a cone which spreads through the three-dimensional space and is defined by lines extending from the center of image capturing by the camera 3002a to each of points on the outline of the foreground mask image 3003 arranged on the image capture plane 3006, is called a visual cone 3004 of the object 3001 captured by the camera 3002a. As illustrated in FIG. 4B, visual cones can be defined for individual cameras 3002a, 3002b, and 3002c. A common region 3005 of the visual cones corresponds to the three-dimensional shape of the object 3001. In this manner, a three-dimensional model of an object can be generated based on the common region 3005.

The database 15 stores data pertaining to the object. For example, the database 15 can store the three-dimensional model of the object, the foreground mask image, the foreground texture image, and the camera parameters.

The image generation apparatus 14 generates a virtual viewpoint image of the object. The image generation apparatus 14 can obtain the three-dimensional model of the object, the foreground texture image, and the camera parameters from the database 15. The image generation apparatus 14 can then generate the virtual viewpoint image of the object using this information. For example, the image generation apparatus 14 can generate the virtual viewpoint image by projecting the three-dimensional model of the object and the foreground texture image onto a virtual viewpoint. The virtual viewpoint may be designated by the user. The virtual viewpoint can be any desired point in the three-dimensional space. The virtual viewpoint can be expressed by the above-described camera parameters.

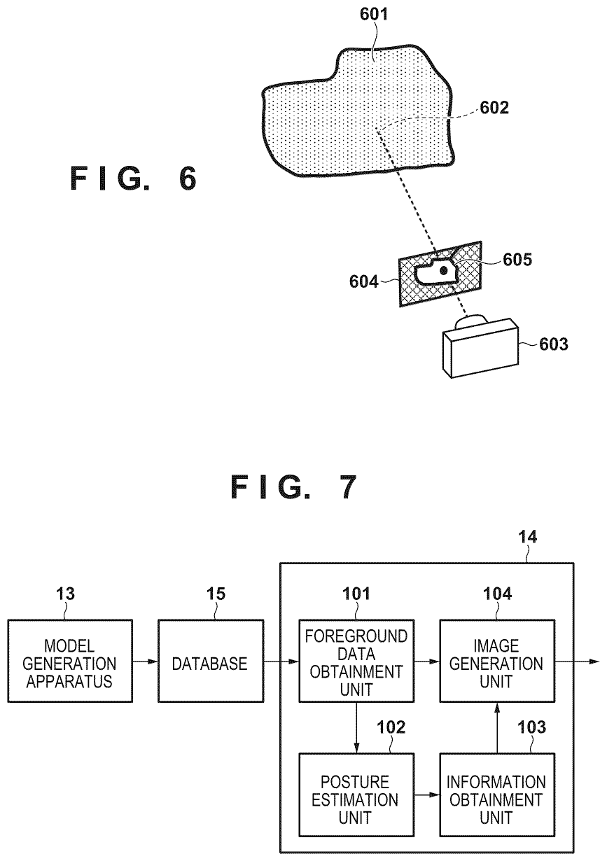

The method for generating the virtual viewpoint image is not particularly limited. For example, the image generation apparatus 14 can add a color to the three-dimensional model of the object. For example, as illustrated in FIG. 6, the image generation apparatus 14 arranges a foreground texture image 604, which is the captured image captured by a camera 603, on the image capture plane of the camera 603 expressed by the camera parameters. The foreground texture image 604 is a captured image of an object expressed by a three-dimensional model 601. The foreground texture image 604 can be a captured image used by the model generation apparatus 13 to generate the three-dimensional model 601. The image generation apparatus 14 further projects a voxel 602, which constitutes part of the three-dimensional model 601 of the object, onto the foreground texture image 604. The image generation apparatus 14 then adds the pixel value of a pixel 605 which, in the foreground texture image 604, corresponds to the position of the voxel 602, to the voxel 602. This results in the voxel being colored. The image generation apparatus 14 can generate a colored three-dimensional model by coloring each voxel constituting the three-dimensional model in this manner. However, the three-dimensional model may be colored by the model generation apparatus 13.

The image generation apparatus 14 can generate the virtual viewpoint image by projecting the colored three-dimensional model onto the virtual viewpoint according to the camera parameters. For example, the virtual viewpoint image can be generated through a ray tracing method. Specifically, the pixel value of a given pixel in the virtual viewpoint image can be determined according to the color of the three-dimensional model at the point of intersection between (i) a line extending from the virtual viewpoint in the direction corresponding to the pixel and (ii) the three-dimensional model. The image generation apparatus 14 may also add a background image to the virtual viewpoint image.

The image generation apparatus 14 can output the virtual viewpoint image generated in this manner. The image generation apparatus 14 may output the virtual viewpoint image to a display connected to the image generation apparatus 14. The image generation apparatus 14 may also output the virtual viewpoint image to an image display apparatus such as a personal computer or a smartphone connected to the image generation apparatus 14 over a network. For example, the image generation apparatus 14 may be a server. In this case, the image generation apparatus 14 can generate the virtual viewpoint image in response to a request from a user terminal, and deliver the virtual viewpoint image to the user terminal. The request from the user terminal may include information designating the virtual viewpoint. The user can view the virtual viewpoint image on the user terminal.

In this manner, the image generation apparatus 14 generates the virtual viewpoint image of the object in accordance with the three-dimensional model of the object. However, the image generation apparatus 14 further generates this virtual viewpoint image in accordance with information indicating a situation of the object. The specific method for generating the virtual viewpoint image will be described later.

Note that the image generation system 1 can generate virtual viewpoint video constituted by a plurality of virtual viewpoint images. In other words, the camera array 10 can, in synchronization with each other, capture images of an object at a plurality of different times. In addition, the model generation apparatus 13 can generate a three-dimensional model of an object at each of the times based on a plurality of foreground mask images at the corresponding times, obtained from the plurality of captured images at the corresponding times. The virtual viewpoint image at each time can be generated based on this information. The virtual viewpoint video includes the time-series virtual viewpoint images generated in this manner.

In FIG. 1, the foreground extraction apparatuses 11a to 11r and the model generation apparatus 13 are connected in a star-shaped topology. However, the connection format is not particularly limited. For example, the foreground extraction apparatuses 11a to 11r and the model generation apparatus 13 may be connected in a ring-shaped topology using a daisy-chain connection, or a bus-shaped topology.

### Image Generation Apparatus

The configuration of the image generation apparatus 14, which is an image processing apparatus according to one embodiment, will be described hereinafter with reference to the block diagram in FIG. 7.

A foreground data obtainment unit 101 obtains the three-dimensional model of an object. The foreground data obtainment unit 101 can obtain the three-dimensional model of the object from the database 15. The foreground data obtainment unit 101 can also obtain the camera parameters of the cameras 10a to 10r, the foreground texture images, and the foreground mask images from the database 15. Note that the foreground data obtainment unit 101 may generate the three-dimensional model of the object in the same manner as the model generation apparatus 13.

A posture estimation unit 102 obtains posture information indicating a posture of the object. The posture estimation unit 102 can estimate the posture of the object, for example. The method by which the posture estimation unit 102 estimates the posture of the object is not limited. The posture estimation unit 102 can estimate the posture of the object based on the captured image of the object captured by each of the plurality of cameras. In the following example, the posture estimation unit 102 estimates the posture of an object, which is a person, based on the captured images (foreground texture images) and camera parameters of the cameras 10a to 10r, obtained by the foreground data obtainment unit 101.

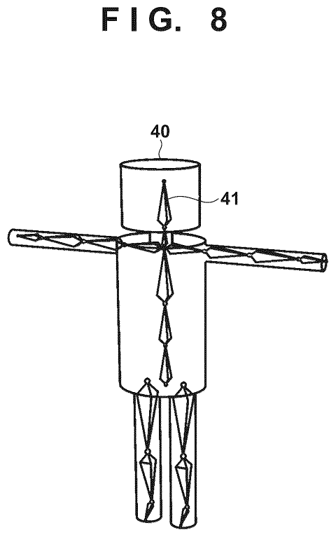

Posture estimation makes it possible to visualize a person's posture. The data calculated through the posture estimation is called “posture information”. The posture estimation unit 102 can estimate the posture of the object based on the positions of joints. The posture information is expressed, for example, as a collection of object items representing a skeleton, referred to as “bones”, which connect the joints of a detected person to each other. FIG. 8 illustrates bones 41 representing the posture information of a person as an example of the posture information. The bones 41 represent a skeleton and correspond to the person's waist, abdomen, chest, neck, head, shoulders, arms, hands, legs, and ankles. The skeleton representing the posture information is not limited to the foregoing, however. For example, the skeleton expressing the posture information may be based on fingers, facial expressions, or the like.

The posture estimation unit 102 can detect two-dimensional or three-dimensional coordinates of feature points such as the joints, eyes, or nose of a person. The posture estimation unit 102 can then generate the posture information based on these coordinates. As a specific example, the posture estimation unit 102 can estimate the two-dimensional posture of an object based on the captured images obtained by the cameras 10a to 10r, respectively. The posture estimation unit 102 can then estimate the three-dimensional posture of the object by combining the two-dimensional posture of the object estimated from each of the captured images with the camera parameters of the cameras 10a to 10r, respectively.

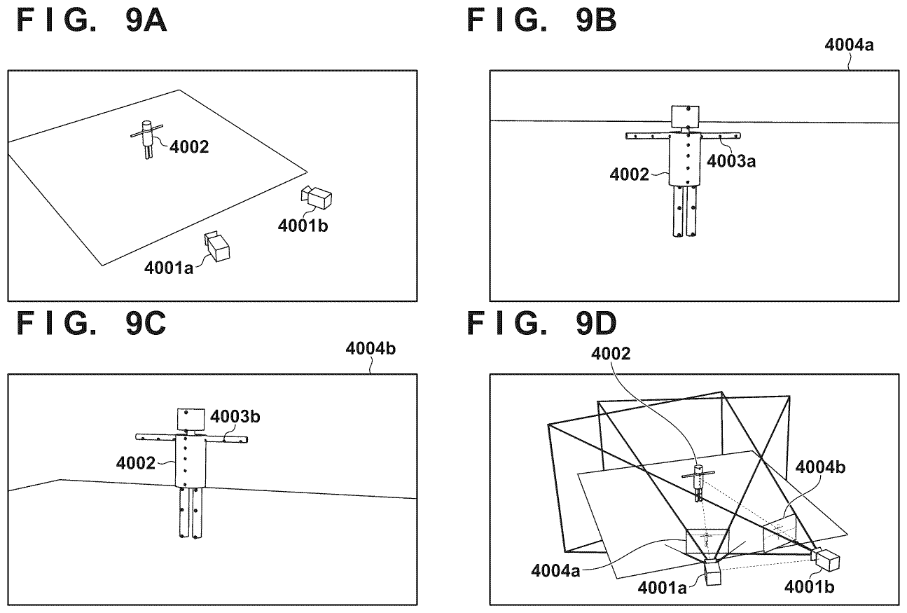

FIGS. 9A to 9D illustrate an example of estimating a three-dimensional posture on the basis of the results of estimating the two-dimensional posture based on the plurality of captured images. FIG. 9A is a bird's-eye view illustrating a state in which an object 4002 is captured using two cameras 4001a and 4001b. FIG. 9B illustrates a result of estimating the position of a joint 4003a, which is a feature point of the object 4002, in the captured image captured by the camera 4001a. In the example in FIG. 9B, the head, chin, neck, chest, abdomen, hips, shoulders, elbows, wrists, thighs, feet, knees, and ankles are detected as joints. Likewise, FIG. 9C illustrates a result of estimating the position of a joint 4003b, which is a feature point of the object 4002, in the captured image captured by the camera 4001b. The method for estimating the position of the joint is not limited. For example, markers can be added to the person's joints in advance. In this case, the positions of the joints can be detected based on the positions of the markers detected from the captured images. The posture of the object in the two-dimensional captured image can be estimated in this manner.

FIG. 9D illustrates a method of calculating the three-dimensional position of the joints of the object based on the captured images captured by the two cameras 4001a and 4001b. As illustrated in FIG. 9D, the three-dimensional position of the chest of the object can be estimated geometrically using triangulation based on the positions of the cameras 4001a and 4001b in the three-dimensional space and the estimated position of the chest of the object in the captured images. The calculation of the three-dimensional position through triangulation can be performed according to a standard method. Performing such processing on each of the feature points makes it possible to estimate the three-dimensional position of the feature points of the object, which in turn makes it possible to estimate the three-dimensional posture of the object.

However, the method for estimating the posture of the object is not limited to the method described above. For example, the posture estimation unit 102 may estimate the positions of the joints based on feature points of the person detected from the captured images, instead of using markers. The posture estimation unit 102 may also estimate the posture of the object using a range sensor or the like.

An information obtainment unit 103 obtains information indicating the situation of the object (called “object information” hereinafter). The object information is, for example, information determined based on the position, shape, or appearance of the object. The information obtainment unit 103 can generate the object information based on the captured images of the object. However, the information obtainment unit 103 may obtain object information generated in advance.

In the present embodiment, the information obtainment unit 103 generates the object information based on the results of estimating the posture of the object. In other words, the information obtainment unit 103 obtains the posture information calculated by the posture estimation unit 102, and generates the object information based on the posture information. The posture information is generated based on captured images expressing the position, shape, and appearance of the object, captured by the plurality of cameras, as described above. The posture information itself also expresses the position and shape of the object. In this manner, the information obtainment unit 103 can use the posture information to generate the object information based on the position, shape, or appearance of the object. The information obtainment unit 103 then outputs the obtained object information to an image generation unit 104.

The object information in the present embodiment is information calculated based on the position, posture, shape, or appearance of the object across a plurality of times (called “statistical information” hereinafter). Tracking information, motion analysis information, and event information can be given as examples of the statistical information.

“Tracking information” is information specifying the position of the object in time series. For example, the tracking information may be an ID capable of uniquely identifying a player participating in a game. Such an ID may be assigned to the posture information of the object at each time, calculated by the posture estimation unit 102. The information obtainment unit 103 can determine the posture information from a past time which corresponds to the posture information from a new time. For example, the information obtainment unit 103 can associate the posture information from a new time with the posture information from a past time based on the proximity of the position of the object expressed by the posture information, or based on movement of the object expressed by the posture information. The information obtainment unit 103 can then assign the same ID to the posture information from the new time as the posture information from the corresponding past time. In this manner, based on the posture information, the information obtainment unit 103 can assign the same ID to the same object by determining the object expressed by the posture information. The tracking information may be information indicating a movement trajectory of the object. The information obtainment unit 103 can generate such a movement trajectory based on the associations between instances of the posture information as described above.

“Event information” is information indicating an event that has occurred with respect to an object. The event information may be information indicating movement of the object, a change in the posture, a change in the shape, or a result of classifying the situation. The event information may be information indicating that the object has moved in a specific way or the posture has changed, for example. For example, the event information for a game may be information indicating that a point has been scored, information indicating that a foul has been committed, or information indicating that a specific play has been made. As a specific example, the event information for soccer may be information indicating that a shot, goal, or a penalty kick has been made.

Such event information can be generated in accordance with a change in the movement or the posture information for one or more objects over time. For example, the information obtainment unit 103 can determine that a specific event has occurred by comparing the changes over time of the posture information for one or more objects with a pattern of changes in posture information defined in advance for the event. For example, the information obtainment unit 103 can determine that a shot has been made by comparing changes over time in the positions of feet, indicated by the posture information of a player, and the changes over time in the position of a ball, indicated by the posture information of the ball, with a pattern of changes in the posture information that corresponds to a shot.

Injury risk information can also be given as an example of the event information. “Injury risk information” is information indicating that a risk of injury has been detected for an object such as a person. The information obtainment unit 103 can detect the risk of an injury when an object has moved in a specific way, for example. Postures which involve high and low risks of injury can be determined in advance according to the structure of the person's joints. For example, the risk of a foot injury can be determined based on the positions of the ankles and knees. The information obtainment unit 103 can detect the risk of an injury by comparing the posture information of the person with a predetermined posture. The information obtainment unit 103 may also take into account the speed at which the posture changes in order to detect the risk of an injury. For example, the information obtainment unit 103 can determine whether there is a risk of a foot injury based on (i) the angles and speeds of the ankles and knees indicated by the posture information and (ii) predetermined thresholds. The information obtainment unit 103 may also determine the magnitude of the risk of an injury.

“Motion analysis information” is information indicating a result of analyzing the movement of an object. For example, the motion analysis information may be information indicating a statistical value pertaining to the movement of the object. Specifically, the motion analysis information may be information indicating a movement speed of the object. For example, the motion analysis information can express an average movement speed or a maximum movement speed in a predetermined period (e.g., during a game). The motion analysis information can also express a number of movements or a movement time that exceeds a movement distance, a movement time, or a threshold speed of the object in a predetermined period (e.g., during a game). The information obtainment unit 103 can calculate such motion analysis information based on the tracking information of an object corresponding to a player or changes over time in the posture information corresponding to the player. The motion analysis information may also express a number of times the object has moved in a specific way within a predetermined period (e.g., a shot). The information obtainment unit 103 can calculate such motion analysis information based on the event information. The motion analysis information may further indicate a degree of fatigue of an object. The degree of fatigue of the object can be calculated, for example, based on a comparison between a movement speed in a past predetermined period of time and a movement speed in a most recent predetermined period of time.

The image generation unit 104 generates the virtual viewpoint image of the object in accordance with the three-dimensional model of the object. The virtual viewpoint image includes the object items based on the three-dimensional model of the object. In the present specification, these object items in the virtual viewpoint image may be referred to simply as the “object”. In the present embodiment, the image generation unit 104 generates the virtual viewpoint image of the object in accordance with the three-dimensional model of the object and the information indicating the situation of the object. For example, the image generation unit 104 can generate the virtual viewpoint image having a display form that is based on the object information of the object indicated in the virtual viewpoint image. As a specific example, the image generation unit 104 may generate the virtual viewpoint image while performing different processing according to the situation of the object. As another specific example, the image generation unit 104 may generate the virtual viewpoint image including information indicating the situation of the object. The image generation unit 104 can then output the virtual viewpoint image obtained in this manner. When generating the virtual viewpoint image of the object for the specific time, the image generation unit 104 can perform processing according to the situation of the object before or after the specific time.

As described earlier, the image generation unit 104 can color the three-dimensional model. Also, as described earlier, the image generation unit 104 can generate the virtual viewpoint image in accordance with the colored three-dimensional model and the virtual viewpoint. FIG. 10 illustrates an example of a virtual viewpoint image generated in this manner. When generating the virtual viewpoint image illustrated in FIG. 10, processing according to the object information is not performed. The virtual viewpoint image can include the object items according to the three-dimensional model of the object (e.g., the player) based on the actual appearance and shape. Objects having simplified shapes are indicated in the virtual viewpoint image illustrated in FIG. 10 for the purposes of these descriptions. However, the virtual viewpoint image may include object items corresponding to a three-dimensional model of the object different from the actual appearance and shape of the object.

In one embodiment, the image generation unit 104 changes a display related to the object in accordance with the object information. The change in the display related to the object may be a change in the display of the object itself, or may be a change in the display of the surroundings of the object. For example, changing the display pertaining to the object may be changing the size of the object, changing the color of the object, changing the color of the surroundings of the object, or adding an object item in the vicinity of the object. The image generation unit 104 may change the display pertaining to the object when the object information satisfies a specific condition. A case where there is a specific movement such as a shot, a case where a specific event such as a goal has occurred, or a case where the movement speed or total distance traveled exceeds a threshold can be given as examples of the specific condition. The image generation unit 104 may also change the display pertaining to the object in accordance with specific parameters indicated by the object information (e.g., in accordance with motion analysis information such as the movement speed or the total movement distance). In this manner, the image generation unit 104 can change the processing used to generate the virtual viewpoint image in accordance with the object information.

The image generation unit 104 can change the display pertaining to the specific object based on the object information pertaining to the specific object. The object information pertaining to the specific object can be, for example, motion analysis information pertaining to the movement of the specific object, or event information pertaining to movement by the specific object. For example, the image generation unit 104 can change the display pertaining to the specific object when the specific object makes a specific movement such as taking a shot. Similarly, the image generation unit 104 can change the display pertaining to an object related to a specific event such as a goal (e.g., the object is the player who scored the goal). For example, the image generation unit 104 can change the display pertaining to the object related to a specific event if the specific event occurred in the past, is currently occurring, or will occur in the future. Note that the method for determining the object related to the specific event may be defined in advance.

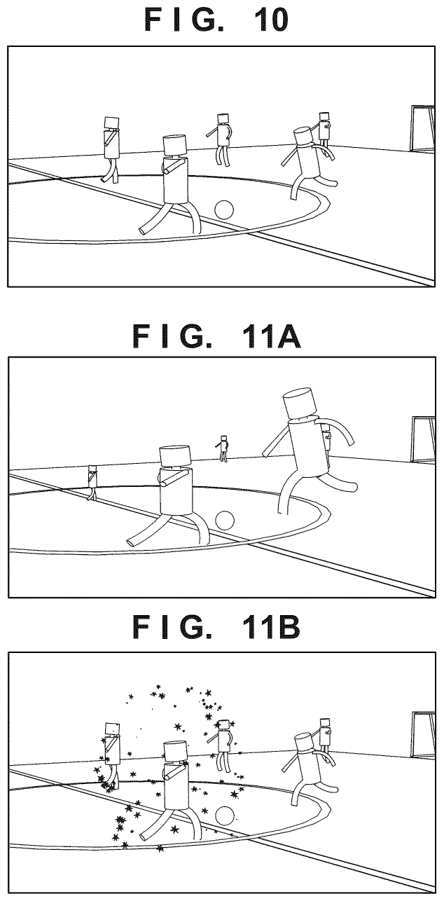

For example, the image generation unit 104 can change the appearance of the object in accordance with the object information. Specifically, the image generation unit 104 can change the size of the three-dimensional model of the object in accordance with the object information. Specifically, the image generation unit 104 can increase the size of the three-dimensional model of the object when the object information satisfies a specific condition. Similarly, the image generation unit 104 can increase the size of the three-dimensional model of the object in accordance with the object information (e.g., in accordance with the motion analysis information), as illustrated in FIG. 11A. The image generation unit 104 can change the size of the three-dimensional model of the object by changing the size of the voxels in the three-dimensional model of the object.

As another example, the image generation unit 104 can change the color of the object in accordance with the object information. For example, the image generation unit 104 can change the color to be added to the voxels in accordance with the object information. Specifically, the image generation unit 104 may change the color of the object in accordance with the object information (e.g., in accordance with the motion analysis information). The image generation unit 104 may also change the display color of the object when the object information satisfies a specific condition. As an alternative method, the image generation unit 104 may add an illumination effect to the object in accordance with the object information (e.g., when the object information satisfies a specific condition). In this case, the image generation unit 104 can generate the virtual viewpoint image in consideration of the illumination from the object. In this case, the object and the object's surroundings become brighter in the virtual viewpoint image.

The image generation unit 104 can also change the appearance of the surroundings of the object in accordance with the object information. For example, the image generation unit 104 can change the color of the surroundings of the object in accordance with the object information. Specifically, the image generation unit 104 may darken the surroundings of the object in accordance with the object information (e.g., when the object information satisfies a specific condition). For example, the image generation unit 104 may darken the background around the object such that the object is more prominent.

As another example, the image generation unit 104 can add object items to the virtual viewpoint image in accordance with the object information. These object items may be three-dimensional object items or two-dimensional object items. The image generation unit 104 can add object items related to the specific object based on the object information pertaining to the specific object. Such object items can be arranged in the vicinity of the specific object.

For example, the image generation unit 104 can add three-dimensional object items or two-dimensional object items to the surroundings of the object in accordance with the object information. Specifically, the image generation unit 104 can add effect voxels to the surroundings of the three-dimensional model of the object when the object information satisfies a specific condition (e.g., when there is a specific movement such as a shot, or when the movement speed exceeds a threshold). For example, the image generation unit 104 can add star-shaped three-dimensional object items to the surroundings of the three-dimensional model of the object in accordance with the object information (e.g., in accordance with the movement speed). FIG. 11B illustrates virtual viewpoint video generated in this manner. The number of object items to be added may be increased in accordance with the object information (e.g., in accordance with the movement speed).

The image generation unit 104 can also add an object item expressing information indicating the situation of the object. This object item can be, for example, a two-dimensional information display region. This enables the image generation unit 104 to superimpose the information indicating the situation of the object on the virtual viewpoint image. For example, statistical information such as that mentioned above can be used to provide information to the user, analyze the tactics of a team, and the like. As such, the image generation unit 104 can add an object item indicating the statistical information to the virtual viewpoint image.

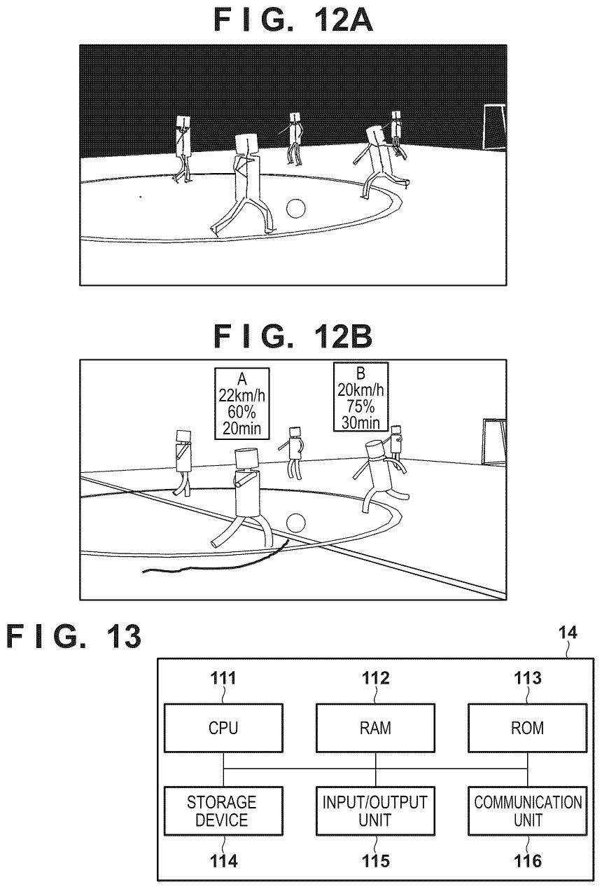

The image generation unit 104 can add an object item indicating information pertaining to a specific object to the vicinity of the specific object. The object item can indicate motion analysis information, for example. The example in FIG. 12B indicates the speed, degree of fatigue, and travel time of an object in an information display region located in the vicinity of the object. In the example illustrated in FIG. 12B, an object item according to the tracking information of the object is added in the vicinity of the object. This object item indicates the movement trajectory of the ball. In this manner, the image generation unit 104 can superimpose information indicating the movement trajectory of the object on the virtual viewpoint image. Note that the object item may indicate other information pertaining to the object. For example, the object item may include information identifying the object, such as the name of the player, as illustrated in FIG. 12B. The information obtainment unit 103 may identify the object through image recognition.

The image generation unit 104 may superimpose object items such as those described above at positions that do not overlap with the foreground. Such a configuration makes it easy to grasp useful information in a visual manner without obscuring the foreground.

As in the example described above, the object to be focused on can be presented to the user by enlarging the object, adding a prominent color to the object, or adding an object item in the vicinity of the object, as special effects. Such a configuration makes it easier to understand the scene expressed by the virtual viewpoint image, which improves the appeal of the virtual viewpoint image. Furthermore, generating the virtual viewpoint image in accordance with statistical information such as that described above makes it easy for the user to recognize the statistical information in a visual manner. Referencing the statistical information makes it even easier to understand the scene, which further improves the appeal of the virtual viewpoint image.

The foregoing has described a case where the statistical information is generated based on the posture information. However, the method for generating the statistical information or the object information is not particularly limited. For example, the statistical information or the object information may be generated based on the three-dimensional model of the object. Here, the object information may be information indicating a change in the shape of the object. As a specific example, the information obtainment unit 103 may calculate an amount of deformation in the shape of the object. An amount of displacement in the shape of a ball used in a game can be given as an example of the amount of deformation. A greater amount of displacement from a sphere indicates that a stronger force has been applied to the ball. As an example, the image generation unit 104 can change the display pertaining to the ball in the same manner as in the above example based on the amount of displacement in the shape of the ball.

The foregoing has described a case where the object information is statistical information. However, the object information is not limited to the statistical information. For example, the object information or the above-described event information may be information indicating that the position, posture, shape, or appearance of the object satisfies a predetermined condition. Alternatively, the object information may be posture information. In other words, the image generation unit 104 may generate the virtual viewpoint image in accordance with the posture information.

For example, the image generation unit 104 may add an object item to the virtual viewpoint image in accordance with the posture information. For example, the image generation unit 104 may superimpose, on a specific object, an object item indicating the posture of the specific object based on the posture information. FIG. 12A illustrates an example of a virtual viewpoint image in which object items indicating postures are superimposed on the virtual viewpoint image. In FIG. 12A, the bones according to the posture information are superimposed on the virtual viewpoint image. Such a configuration makes it easier for the user to visually understand the postures of the players in a scene where a goal is scored or the like, which improves the appeal of the virtual viewpoint image.

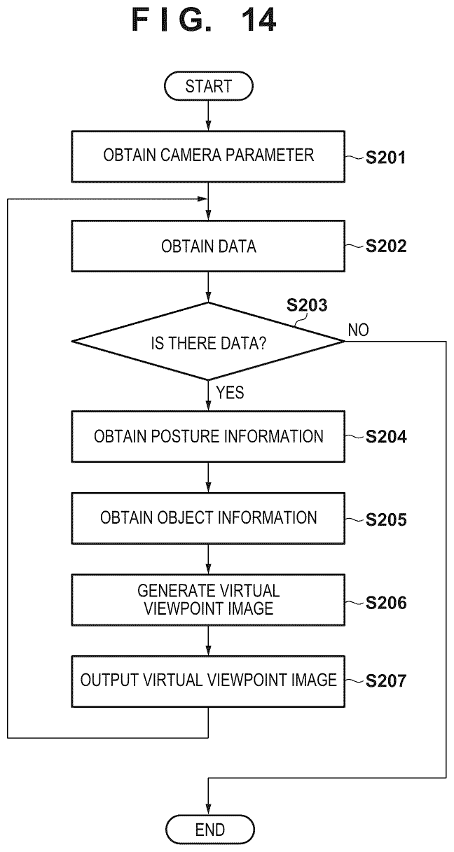

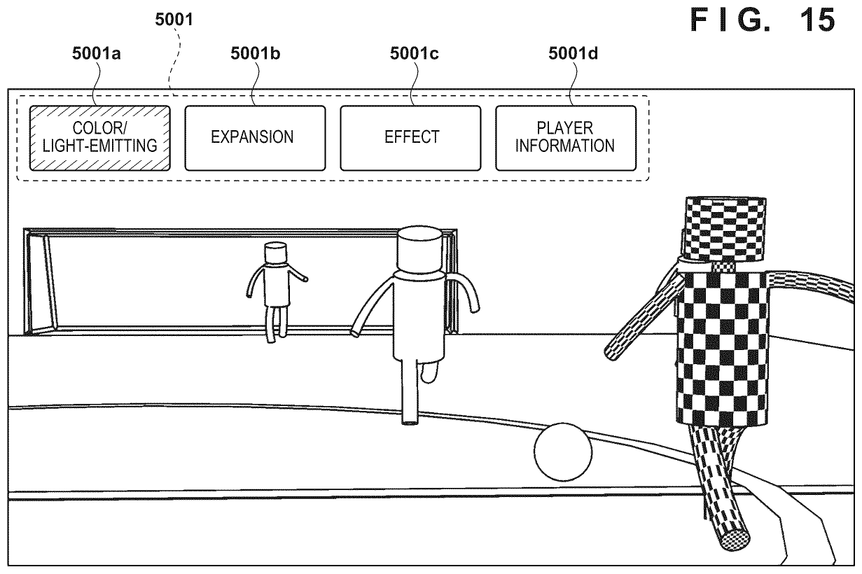

FIG. 13 is a block diagram illustrating the hardware configuration of the image generation apparatus 14 according to one embodiment. A CPU 111 is a central processing unit. The CPU 111 controls the image generation apparatus 14 as a whole by executing programs stored in a ROM 112 or a RAM 113. For example, the CPU 111 can load predetermined programs stored in a storage device 114 into the RAM 113 and execute the programs loaded into the RAM 113.

The ROM 112 is a read-only non-volatile memory. The RAM 113 is randomly-accessible memory. Dynamic random access memory (DRAM) can be used as the RAM 113, for example. The storage device 114 is a high-capacity storage device such as a hard disk, for example.

An input/output unit 115 accepts various user inputs to the image generation apparatus 14. The input/output unit 115 can also output various types of information. The input/output unit 115 can include, for example, one or more of a keyboard, a mouse, a display, and a touch panel. A communication unit 116 controls communication between the image generation apparatus 14 and an external apparatus. In the present embodiment, the control apparatus 12 and the database 15 are connected to the communication unit 116. In addition, the external apparatus can be connected to the communication unit 116 over a network such as a LAN.

In this manner, the image processing apparatus according to one embodiment can be realized by a computer including a processor and a memory. In other words, the functions of the units illustrated in FIG. 7 and the like can be implemented by a processor such as the CPU 111 executing programs stored in a memory such as the ROM 112 or the RAM 113. However, the functional units of the image generation apparatus 14 may be realized by software and hardware, such as dedicated ICs, operating cooperatively. Some or all of the functional units of the image generation apparatus 14 may be realized by hardware alone. On the other hand, the image generation apparatus 14 according to one embodiment may be constituted by a plurality of information processing apparatuses connected over a network, for example. In other words, the processing performed by the functional units of the image generation apparatus 14 may be executed by a plurality of information processing apparatuses in a distributed manner. In this manner, the functions of the image generation apparatus 14 may be provided as a cloud service.

FIG. 14 is a diagram illustrating the flow of processing in an image processing method performed by the image generation apparatus 14 according to one embodiment. According to the processing illustrated in FIG. 14, a virtual viewpoint image corresponding to each of times is generated. The virtual viewpoint images generated in this manner correspond to respective frames of a virtual viewpoint video.

In step S201, the foreground data obtainment unit 101 obtains the camera parameters for all of the cameras 10a to 10r from the database 15. In step S202, the foreground data obtainment unit 101 obtains the three-dimensional model of the object, the foreground mask image, and the foreground texture image from the database 15 as described above. In steps S201 and S202, the foreground data obtainment unit 101 obtains these instances of data for a new time. If the data for the new time cannot be obtained in step S203, the processing illustrated in FIG. 14 ends.

If data for the new time has been successfully obtained in step S203, the sequence moves to step S204. In step S204, the posture estimation unit 102 calculates the posture information of the object as described above. In step S205, the information obtainment unit 103 obtains the object information as described above. In order to calculate the statistical information, the information obtainment unit 103 may refer to information of the object (e.g., the posture information, the three-dimensional model, or other information) from a past or future time. In step S206, the image generation unit 104 generates the virtual viewpoint image based on the object information as described above. In step S207, the image generation unit 104 outputs the image generated in step S206. The sequence then returns to step S202.

As described above, generating a virtual viewpoint image in accordance with information indicating the situation of an object makes it possible to increase the appeal of the virtual viewpoint image to the user. For example, according to some embodiments, it may be easier for the user to be able to grasp the situation of the object. Furthermore, according to some embodiments, a highly-appealing virtual viewpoint image to which a special effect has been added can be generated.

### Display Mode Selection

As described above, the image generation unit 104 can generate the virtual viewpoint image while using various processing in accordance with the object information. The processing described above can also be used in combination. Furthermore, the processing used to generate the virtual viewpoint image may be selectable by the user. For example, the user can select which processing to use. The user can also select what object information should be referenced to control the processing. The user may select one display mode from a plurality of display modes. In each of the plurality of display modes, the virtual viewpoint image is generated using the object information through different processing. In other words, a virtual viewpoint image in a different display format is displayed in each of the plurality of display modes. The virtual viewpoint images displayed in the respective display modes may be, for example, the virtual viewpoint images illustrated in FIG. 11A, 11B, 12A, or 12B.

For example, in addition to the virtual viewpoint image, a button group 5001 for the user to select the display mode is provided in the user interface, as illustrated in FIG. 15. A display mode in which the color of the object is changed (or the object is illuminated) in accordance with the object information is selected by selecting a button 5001a. A display mode in which the size of the object is changed in accordance with the object information is selected by selecting a button 5001b. A display mode in which voxels are added in the periphery of the object for effect is selected by selecting a button 5001c. Finally, a display mode in which information pertaining to the object, such as the movement speed, is displayed is selected by selecting a button 5001d.

The image generation unit 104 can output such a user interface to the user through the input/output unit 115 or the communication unit 116, for example. The image generation unit 104 can also receive user inputs for selecting the display mode through the input/output unit 115 or the communication unit 116, for example. The image generation unit 104 can then generate the virtual viewpoint image in accordance with the display mode selected by the user in this manner.

Note that the plurality of display modes may include a display mode for outputting a virtual viewpoint image such as that illustrated in FIG. 10. In this case, the image generation unit 104 does not generate the virtual viewpoint image based on the object information. In this case, the processing performed by the posture estimation unit 102 and the information obtainment unit 103 can be omitted.

### Granting Rights Corresponding to Object Information or Display Mode

The virtual viewpoint image according to a specific display mode may be output only when the user has rights which correspond to the specific display mode. For example, the image generation unit 104 can search for a display mode to which the user has a right. The image generation unit 104 can then generate the virtual viewpoint image in accordance with the display mode to which the user has the right. In this case, only the button corresponding to the display mode for which the user has the right may be displayed in the button group 5001.

The image generation unit 104 can also receive a request to output the virtual viewpoint image corresponding to a specific display mode from the user or the user terminal. At this time, the image generation unit 104 can determine whether the user has the right corresponding to the specific display mode. The image generation unit 104 can generate the virtual viewpoint image based on the object information, corresponding to the display mode, in response to a determination that the user has the right to the specific display mode. In other words, the image generation unit 104 can generate the virtual viewpoint image according to a specific display mode in response to a determination that the user has the right to the specific display mode. For example, the button group 5001 may include a button corresponding to a display mode to which the user has a right and a button corresponding to a display mode to which the user does not have a right. In this case, the image generation unit 104 can determine whether the user has the right to the selected display mode. If the user does not have the right corresponding to the selected display mode, the image generation apparatus 14 may start processing for the user to obtain the right corresponding to the selected display mode. In one embodiment, if the user does not have the right corresponding to the display mode, a virtual viewpoint image such as that illustrated in FIG. 10 is output.

The user may also have a right to the object information, e.g., the statistical information or the posture information described above. For example, the user may have a right to a specific type of object information, or a right to the object information for a specific object. The virtual viewpoint image generated as described above in accordance with the object information may be output only when the user has the right corresponding to the specific object information. In one embodiment, the image generation unit 104 can determine whether the user has the right corresponding to the specific object information. The image generation unit 104 can then generate the virtual viewpoint image of the object as described above in accordance with the specific object information, in accordance with the user being determined to have the right corresponding to the specific object information. The right corresponding to the specific display mode may be the right to the object information used to generate the virtual viewpoint image in the specific display mode. In other words, the image generation unit 104 can generate the virtual viewpoint image based on the display mode in which the virtual viewpoint image according to the specific object information is output, in accordance with the user being determined to have the right corresponding to the specific object information.

The user may purchase the right to specific object information. Likewise, the user may purchase the right corresponding to a specific display mode. For example, the user can view a highly-appealing virtual viewpoint image, such as that illustrated in FIGS. 11A and 11B or FIGS. 12A and 12B, by purchasing the right corresponding to the display mode in which object items for effect are added in the periphery of the object.

Such rights to specific object information or rights corresponding to specific display modes can be managed using NFTs. “NFT” is an acronym for “Non-Fungible Token”. An NFT is a token that expresses the ownership of a unique item as digital data. Codes such as item information and ownership information can be assigned to an NFT. NFTs are stored on a blockchain. An NFT corresponding to the object information or the display mode can be issued in this case. Such an NFT may be issued for each of the various types of object information. For example, an NFT may be issued for tracking information, motion analysis information, event information, injury risk information, movement speed, or information indicating that a shot has been made. In addition, such an NFT may be issued for each of various objects (e.g., each player or a ball). The user can obtain the right corresponding to the object information or the display mode corresponding to the NFT by purchasing the NFT. In this example, the virtual viewpoint image generated in accordance with the specific object information or the virtual viewpoint image according to the specific display mode is provided only to the user who holds the NFT.

Blockchain is a technology that uses cryptographic techniques to synchronously record data to multiple computers that constitute a distributed network. In a blockchain, data generated within a certain period of time is collected into a block. The data is verified between computers. In this manner, correct records are linked together like a chain. In such a blockchain, even if data is tampered with by some of the computers, the correct data is selected by a majority vote of the computers, which makes it possible to prevent data from being tampered with.

In such a configuration, the image generation unit 104 can determine whether the user owns the NFT corresponding to the specific object information. Such verification can be performed using conventional blockchain technology. The image generation unit 104 can generate the virtual viewpoint image based on the object information in order to generate the virtual viewpoint image in accordance with the determination that the user owns the NFT corresponding to the specific object information, and then output the virtual viewpoint image to the user. Likewise, in accordance with a determination that the user owns the NFT corresponding to a specific display mode, the image generation unit 104 can generate the virtual viewpoint image according to that display mode, and output the virtual viewpoint image to the user. The image generation unit 104 can issue NFTs in this manner. An NFT management unit (not shown) included in the image generation apparatus 14 or the image generation system 1 can issue NFTs in this manner.

Such a configuration makes it possible to turn the right to view an appealing virtual viewpoint image into an asset.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-108527, filed Jun. 30, 2023, which is hereby incorporated by reference herein in its entirety.

What is claimed is:

1. An image processing apparatus comprising one or more memories storing instructions and one or more processors that execute the instructions to:
obtain a three-dimensional model of an object;
obtain information indicating a situation of the object; and
generate the virtual viewpoint image of the object according to the three-dimensional model of the object and the information indicating the situation of the object.

2. The image processing apparatus according to claim 1, wherein the one or more processors execute the instructions to:
estimate a posture of the object based on captured images of the object captured by each of a plurality of cameras.

3. The image processing apparatus according to claim 2,
wherein the object is a person, and the one or more processors execute the instructions to estimate the posture of the object based on a position of a joint of the person.

4. The image processing apparatus according to claim 1, wherein the one or more processors execute the instructions to:
generate the information indicating the situation of the object based on a captured image of the object.

5. The image processing apparatus according to claim 1, wherein the one or more processors execute the instructions to:
generate the information indicating the situation of the object based on a result of determining a posture of the object.

6. The image processing apparatus according to claim 1,
wherein the information indicating the situation of the object is information calculated based on a change in a position, a posture, a shape, or an appearance of the object across a plurality of times.

7. The image processing apparatus according to claim 1,
wherein the information indicating the situation of the object is information indicating an event that has occurred in relation to the object.

8. The image processing apparatus according to claim 1,
wherein the information indicating the situation of the object is information indicating movement of the object, a change in a posture of the object, a change in a shape of the object, or a result of classifying the situation.

9. The image processing apparatus according to claim 1,
wherein the information indicating the situation of the object is information indicating that a specific movement or posture change has occurred in the object.

10. The image processing apparatus according to claim 1,
wherein the information indicating the situation of the object is information indicating a result of analyzing movement of the object.

11. The image processing apparatus according to claim 1,
wherein the information indicating the situation of the object is information indicating a movement speed or an amount of deformation of a shape of the object.

12. The image processing apparatus according to claim 1,
wherein the information indicating the situation of the object is information specifying positions of the object in time series, or information indicating a posture of the object.

13. The image processing apparatus according to claim 1, wherein the one or more processors execute the instructions to:
change a display pertaining to the object in the virtual viewpoint image in accordance with the information indicating the situation of the object.

14. The image processing apparatus according to claim 1, wherein the one or more processors execute the instructions to:
change a size or a color of the object in the virtual viewpoint image in accordance with the information indicating the situation of the object.

15. The image processing apparatus according to claim 1, wherein the one or more processors execute the instructions to:
add an object item in a periphery of the object in accordance with the information indicating the situation of the object.

16. The image processing apparatus according to claim 1, wherein the one or more processors execute the instructions to:
superimpose the information indicating the situation of the object on the virtual viewpoint image.

17. The image processing apparatus according to claim 1, wherein the one or more processors execute the instructions to:
determine whether a user has a right corresponding to a display mode, and when the user is determined to have the right corresponding to the display mode, generate a virtual viewpoint image of the object, according to the information indicating the situation of the object, that corresponds to the display mode.

18. The image processing apparatus according to claim 1, wherein the one or more processors execute the instructions to:
determine whether a user owns an NFT corresponding to the information indicating the situation of the object, and when the user is determined to own the NFT corresponding to the information indicating the situation of the object, generate a virtual viewpoint image of the object according to the information indicating the situation of the object.

19. An image processing method comprising:
obtaining a three-dimensional model of an object;
obtaining information indicating a situation of the object; and
generating the virtual viewpoint image of the object according to the three-dimensional model of the object and the information indicating the situation of the object.

20. A non-transitory computer-readable medium storing a program executable by a computer to perform a method comprising:
obtaining a three-dimensional model of an object;
obtaining information indicating a situation of the object; and
generating the virtual viewpoint image of the object according to the three-dimensional model of the object and the information indicating the situation of the object.
